(19) United States
(12) Patent Application Publication
(10) Pub. No.: US 2008/0096549 A1
(43) Pub. Date: Apr. 24, 2008

(54) MOBILE COMMUNICATION TERMINAL

(76) Inventor: Juha ARRASVUORI, Tampere (FI)

Correspondence Address: PERMAN & GREEN, 425 POST ROAD, FAIRFIELD, CT, 06824, US

(21) Appl. No.: 11/552,365

(22) Filed: Oct. 24, 2006

(51) Int. Cl. H04Q 7/20

(52) U.S. Cl. 455/425

(57) ABSTRACT

A method for personalizing a mobile communication terminal, the mobile communication terminal including software for generating a software generated character, the method including displaying a plurality of character options; detecting a user input indicating a selection of one of the plurality of character options, the selection representing a selected option matching a physical personalization of the mobile communication terminal; and when generating the software generated character, considering the selected option. A corresponding mobile communication terminal and computer program product are also presented.

### FIELD

The disclosed embodiments generally relate to mobile terminals and more particularly to personalization of mobile terminals.

### BACKGROUND

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), electronic games such as single-user and online multiplayer games, digital image, audio or video recording, FM radio, music playback, calendar/organizer/time planner, word processing, etc. Furthermore, the modern terminals have local connectivity abilities, such as Bluetooth, allowing the mobile terminals to communicate with a wide array of devices.

With the improved user interface, including color screens, users have been given the ability to change the appearance of the user interface in the mobile terminal, to the personal liking of the user, also known as personalization. For example, the user can modify colors used in the user interface or an image used on a standby screen of the phone. Consequently, one user may personalize the mobile terminal with an image for a particular football team and another user may user an image for the music group “Outkast”.

The current way of personalizing a mobile terminal allow personalization to some degree, but there is a general problem of how to enhance and improve personalization to make the user experience as pleasant, personal and easy as possible.

Consequently, there is a need for an improved mobile communication terminal addressing the problems discussed above.

### SUMMARY

In view of the above, the disclosed embodiments aim to solve or at least reduce the problems discussed above.

A first aspect of the disclosed embodiments is a method for personalizing a mobile communication terminal, the mobile communication terminal comprising software for generating a software generated character, the method comprising: displaying a plurality of character options; detecting a user input indicating a selection of one of the plurality of character options, the selection representing a selected option matching a physical personalization of the mobile communication terminal; and when generating the software generated character, considering the selected option. This allows the user to personalize the mobile communication terminal in two matching ways, increasing the weight of the personalization compared to the prior art.

The considering the selected option may involve: when generating the software generated character, considering the selected option by applying an appearance corresponding to the option.

The considering the selected option may involve: when generating the software generated character, considering the selected option by applying a behavior corresponding to the option.

The behavior may be a behavior related to a characteristic selected from the group consisting of: intelligence, empathy, stamina, curiosity, and temper.

The considering the selected option may involve: when generating the software generated character, considering the selected option by applying a behavior corresponding to the option, the behavior being retrieved from a remote storage over a digital network.

The method may further comprise, prior to the displaying a plurality of character options: depending on a state of the software for displaying a software generated character, determining allowable character options; and wherein the displaying a plurality of character options may involve: displaying a plurality of character options, including the allowable character options, and indicating that each of the allowable character options is user selectable.

The displaying a plurality of character options, detecting a user input, and considering the selection option may be repeated for a second option matching a second physical personalization of the mobile communication terminal.

The software for displaying a software generated character may be a software selected from the group consisting of a single-user game, an online multiplayer game, an online chat application and an avatar generating software.

A second aspect of the disclosed embodiments is a mobile communication terminal enabling personalization, the mobile communication terminal comprising a controller, a display, memory, a location on the exterior of the mobile communication terminal enabling physical personalization and software for generating a software generated character, wherein: the controller is configured to, when generating the software generated character, consider a user selected option for the software generated character, the user selected option matching a physical personalization of the mobile communication terminal.

The mobile communication terminal may be configured to enable the user to apply stickers to the location on the exterior.

The mobile communication terminal may be configured to enable the user to apply pins to the location on the exterior.

A third aspect of the disclosed embodiments is a mobile communication terminal enabling personalization, the mobile communication terminal comprising a controller; a display; a location on the exterior of the mobile communication terminal enabling physical personalization; software for generating a software generated character; means for displaying a plurality of character options; means for detecting a user input indicating a selection of one of the plurality of character options, the selection representing a selected option matching a physical personalization of the mobile communication terminal; and mans for when generating the software generated character, considering the selected option.

A fourth aspect of the disclosed embodiments is a system comprising: a mobile communication terminal enabling personalization, the mobile communication terminal comprising a controller, a display, memory, a digital network interface, a location on the exterior of the mobile communication terminal enabling physical personalization and software for generating a software generated character, wherein: the controller is configured to, when generating the software generated character, considering a user selected option for the software generated character, the user selected option matching a physical personalization of the mobile communication terminal; and a server connected to a digital network, the server being configured to receive a personalization message related to the mobile communication terminal, the personalization message comprising data related to the physical personalization.

The server may further be configured to, based on the personalization message, provide a corresponding authorization message to the mobile communication terminal, and the controller may further be configured to, as a response to a received authorization message allow a user to select a user selectable option corresponding to the authorization message.

A fifth aspect of the disclosed embodiments is a computer program product comprising software instructions that, when executed in a mobile communication terminal, performs the method according to the first aspect.

Other features and advantages of the disclosed embodiment will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments will now be described in more detail, reference being made to the enclosed drawings, in which:

FIG. 1 is a schematic illustration of a cellular telecommunication system, as an example of an environment in which the aspects of the disclosed embodiments may be applied.

FIG. 2 is a schematic front view illustrating a mobile terminal according to one embodiment.

FIG. 3 is a schematic block diagram representing an internal component, software and protocol structure of the mobile terminal shown in FIG. 2.

FIG. 4 is a flowchart diagram illustrating the execution of the mobile terminal shown in FIG. 2 for personalization.

FIG. 5a-d illustrate the use of the mobile terminal shown in FIG. 2 for personalization.

FIG. 6 shows another way of personalizing a mobile terminal.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

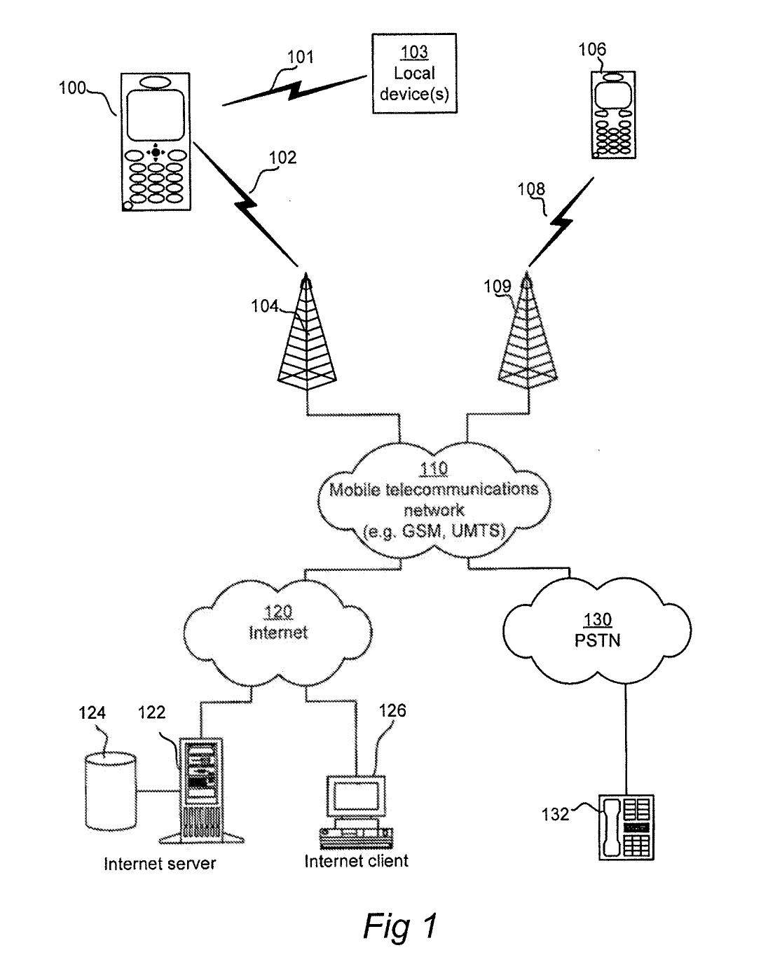

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be microphones, headsets, GPS receivers etc.

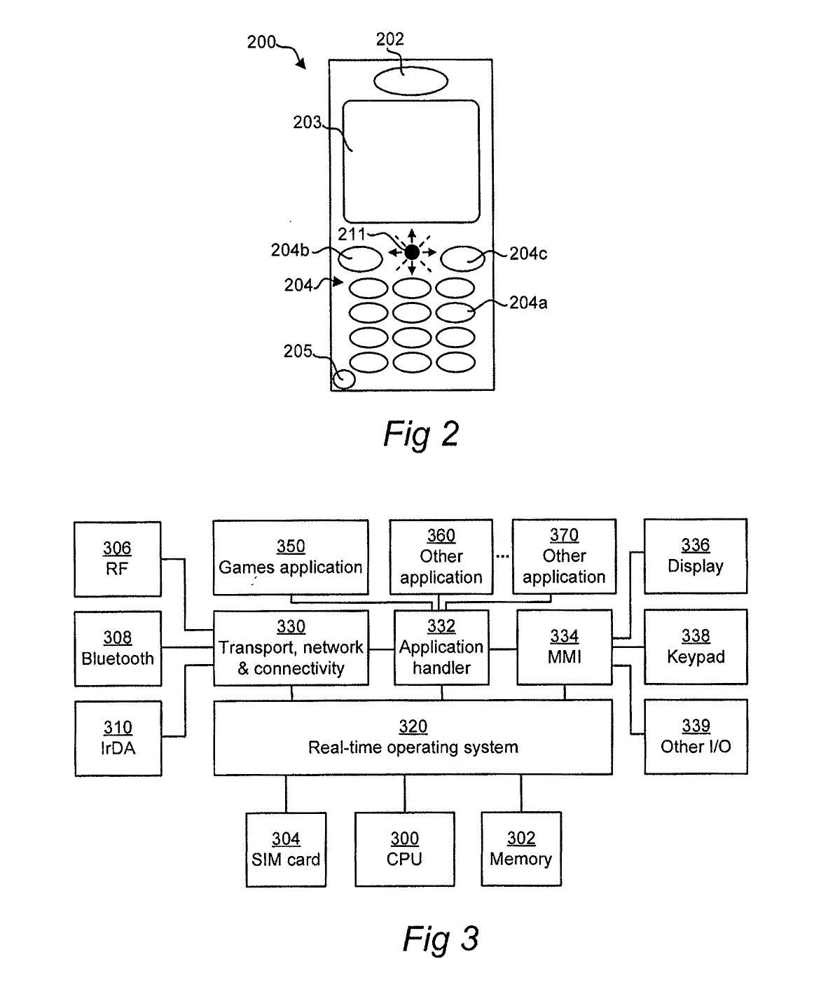

An embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, hard drive, optic memory or any combination thereof. The memory 302 is used for various purposes by the controller 300, one of them being for storing data and program instructions for various software in the mobile terminal. The memory 302 can be internal to the mobile terminal or an external memory connected to the mobile terminal. The software includes a real-time operating system 320, drivers for a man-machine interface (MMI) 334, an application handler 332 as well as various applications. The application handler can include an environment where user installed games can be executed, e.g. a KVM (kilobyte virtual machine) or JVM (Java virtual machine) for executing java applications. The applications can include a games application 350, as well as various other applications 360 and 370, such as applications for voice calling, video calling, sending and receiving SMS, MMS or email, contact management, voice clip recording, web browsing, an instant messaging application, a calendar application, a control panel application, a camera application, a media player, more video games, a notepad application, etc.

The MMI 334 also includes one or more hardware controllers, which together with the MMI drivers cooperate with the display 336/203, keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

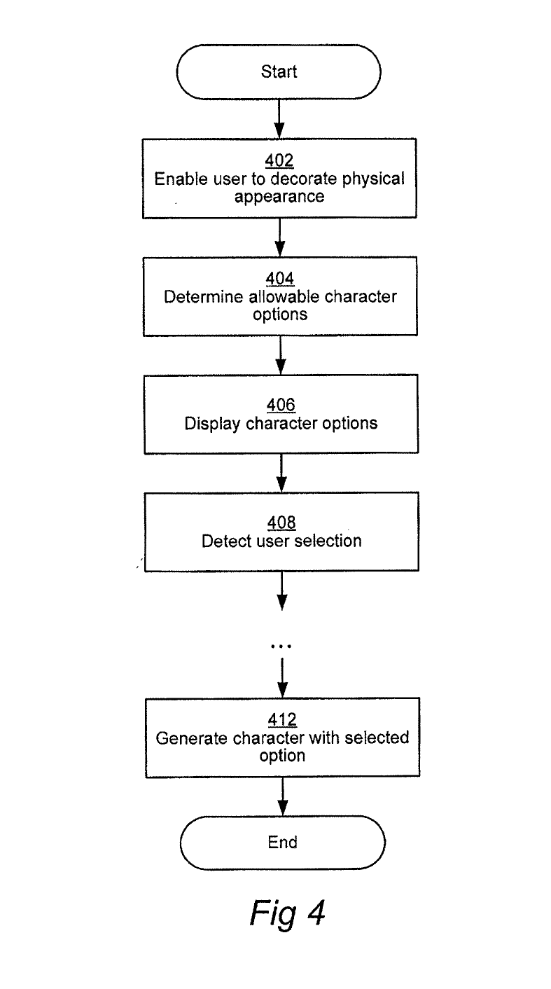

FIG. 4 is a flowchart diagram illustrating the execution of the mobile terminal shown in FIG. 2 for personalization of a software generated character. Software generated characters are used in a variety of different situations. For example, in a game, any character in the game is a software generated character, the game being a single-user game, a multiplayer game or an online multiplayer game, or digital pet software, e.g. tamagotchi software. Moreover, software generated characters can be used in online chat applications, allowing remote users of the chat to see the software generated character representing a local user. Software generated characters could also be used in the user interface of the mobile terminal, simplifying use and making the user experience more pleasant for the user.

In an initial enable user to decorate physical appearance step 402, the user is given the opportunity to decorate the physical appearance of the mobile terminal. The mobile terminal can be provided with a specific location on its exterior, where the user can add personalization items. For example, there may be an area for placing pins or stickers. Alternatively or additionally, the user can personalize the mobile terminal by using a cover of liking.

In a determine allowable character options 404, the mobile terminal determines, from all available options (or icons), what options the user is able to select. Whether a particular option should be allowable for the user to select or not can depend on the state of the software that generates the software generated character. For example, if the character generating software is a military game, the user may only be given the opportunity to select appearance option for military grades in accordance with the level that the user has attained in the game. Furthermore, in one embodiment, when the user wishes to select a matching option, the mobile terminal sends a personalization message to the server. Optionally, a code is requested from the user, which is included in the personalization message. When received by the server, this message can be used on the server to collect statistics, and/or a corresponding authorization message can be generated to be sent from the server to the mobile terminal. If a code is included in the personalization message, the validity of the code is checked and the positive authorization message is only generated if the code is valid. In the embodiment with authorization, the mobile terminal only allows the option corresponding to the authorization message to be selected if the authorization message has been received.

In a display character options step 406, all options are shown on the display of the mobile terminal. If there is not enough space on the display, the user can be given an opportunity to scroll to see all options. Only allowable options are selectable, where unallowable options can be indicated on the display that they are disabled.

In one embodiment, each option can have associated with it a character appearance and/or one or more character behaviors. These character behaviors are later used by the software that generates the character, e.g. a role playing game. For example, one appearance can increase temper with 30 units, while another appearance can increase empathy with 20 units. Any characteristic that is used by the character generating software can be affected by an appearance, for example, but not limited to, intelligence, empathy, stamina, curiosity, and temper. In multi-user software, these properties for behavior can be loaded over a digital network, such as the wide area network 120 (FIG. 1), from a remote server 122 (FIG. 1) and its storage 122 (FIG. 1), when the graphics of the decorations are taken into use with the character. Other people can understand from the decorations of the mobile terminal some of the properties of the virtual character or whatever the user wants to express with these decorations (e.g. individuality or ties to a group). Even if each decoration only has one symbol, multiple meanings can be expressed by combining two or more symbols.

In a detect user selection step 408, the user selection of an option is detected.

The steps of: enable user to decorate physical appearance 402, determine allowable character options 404, display character options 406 and detect user selection 408, can be repeated to allow the user to select options for a plurality of physical personalization items.

In a display character with selected appearance step 412, the selected appearance is applied when the character is displayed by the character generating software. If several options have been selected, all these options are taken into consideration when the character is displayed. Also, any characteristics that are associated with the options are taken into account by the character generating software.

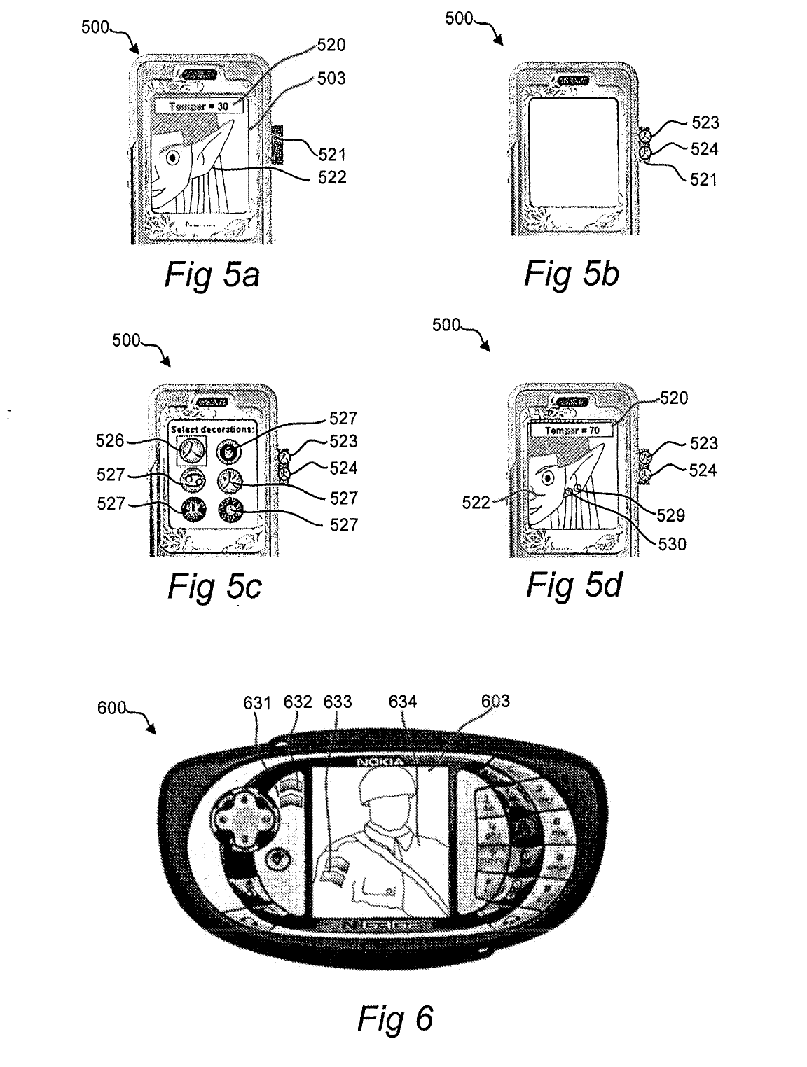

FIG. 5a-d illustrate the use of the mobile terminal shown in FIG. 2 for personalization.

FIG. 5a shows a mobile terminal 500, such as mobile terminal 200 of FIG. 2. The mobile terminal 200 has a location 521 on the exterior of the mobile communication terminal enabling physical personalization. The user of the mobile terminal 500 can e.g. apply stickers or pins to this location, as will be described below. The mobile terminal also comprises a display 503 on which a character 522 is generated by software executing in the mobile terminal 500. The software can for example be a single-user game, an online multiplayer game, an online chat application or an avatar generating software. In many of these software applications, the character has a number of parameters representing different characteristics, where one example is temper. On the display 503, the current value, 30, of the characteristic temper is displayed in a text field 520.

FIG. 5b shows how the user has applied two physical decorations 523, 524 (in this case with the Chinese symbols for “human” and “fire”) to the location 521 for physical personalization on the mobile terminal 500. These decorations can for example be stickers or pins.

In FIG. 5c a number of options 526, 527 are displayed, allowing the user to select an option that matches one of the physical personalizations 523, 524 just applied. In this case, the user has selected one particular option 526. The user would repeat this selection to select options matching both new physical decorations 523, 524.

In FIG. 5d, it is shown how the character 522 is now generated having two earrings 529, 530 matching the physical decorations 523, 524. Furthermore, the text field 520 shows how the characteristic of temper now has increased to a value of 70 units, compared to 30 units initially.

FIG. 6 shows another way of personalizing a mobile terminal. In this example, the character generating software is a military game. The mobile terminal 600 comprises a display 603 showing a character 634 being a soldier. The mobile terminal 600 also comprises a location for applying physical personalizations 631, where the user has applied a sticker 632 denoting a military grade. After the user has updated the game, the character 634 is generated with a military grade symbol 633 matching the physically applied military grade sticker 632.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for personalizing a mobile communication terminal, said mobile communication terminal comprising software for generating a software generated character, said method comprising:
displaying a plurality of character options;
detecting a user input indicating a selection of one of said plurality of character options, said selection representing a selected option matching a physical personalization of said mobile communication terminal; and
when generating said software generated character, considering said selected option.

2. The method according to claim 1, wherein said considering said selected option involves:
when generating said software generated character, considering said selected option by applying an appearance corresponding to said option.

3. The method according to claim 1, wherein said considering said selected option involves:
when generating said software generated character, considering said selected option by applying a behavior corresponding to said option.

4. The method according to claim 3, wherein said behavior is a behavior related to a characteristic selected from the group consisting of: intelligence, empathy, stamina, curiosity, and temper.

5. The method according to claim 3, wherein said considering said selected option involves:
when generating said software generated character, considering said selected option by applying a behavior corresponding to said option, said behavior being retrieved from a remote storage over a digital network.

6. The method according to claim 1, further comprising, prior to said displaying a plurality of character options:
depending on a state of said software for displaying a software generated character, determining allowable character options;
and wherein said displaying a plurality of character options involves:
displaying a plurality of character options, including said allowable character options, and indicating that each of said allowable character options is user selectable.

7. The method according to claim 1, wherein said displaying a plurality of character options, detecting a user input, and considering said selection option are repeated for a second option matching a second physical personalization of said mobile communication terminal.

8. The method according to claim 1, wherein said software for displaying a software generated character is a software selected from the group consisting of a single-user game, an online multiplayer game, an online chat application and an avatar generating software.

9. A mobile communication terminal enabling personalization, said mobile communication terminal comprising a controller, a display, memory, a location on the exterior of said mobile communication terminal enabling physical personalization and software for generating a software generated character, wherein:
said controller is configured to, when generating said software generated character, considering a user selected option for said software generated character, said user selected option matching a physical personalization of said mobile communication terminal.

10. The mobile communication terminal according to claim 9, wherein said mobile communication terminal is configured to enable said user to apply stickers to said location on the exterior.

11. The mobile communication terminal according to claim 9, wherein said mobile communication terminal is configured to enable said user to apply pins to said location on the exterior.

12. A mobile communication terminal enabling personalization, said mobile communication terminal comprising
a controller;
a display;
a location on the exterior of said mobile communication terminal enabling physical personalization;
software for generating a software generated character;
means for displaying a plurality of character options;
means for detecting a user input indicating a selection of one of said plurality of character options, said selection representing a selected option matching a physical personalization of said mobile communication terminal; and
means for when generating said software generated character, considering said selected option.

13. A system comprising:
a mobile communication terminal enabling personalization, said mobile communication terminal comprising a controller, a display, memory, a digital network interface, a location on the exterior of said mobile communication terminal enabling physical personalization and software for generating a software generated character, wherein:
said controller is configured to, when generating said software generated character, considering a user selected option for said software generated character, said user selected option matching a physical personalization of said mobile communication terminal; and
a server connected to a digital network, said server being configured to receive a personalization message related to said mobile communication terminal, said personalization message comprising data related to said physical personalization.

14. The system according to claim 13, wherein said server is further configured to, based on said personalization message, provide a corresponding authorization message to said mobile communication terminal, and said controller is further configured to, as a response to a received authorization message allow a user to select a user selectable option corresponding to said authorization message.

15. A computer program product comprising software instructions that, when executed in a mobile communication terminal, performs the method according to claim 1.
